(19) United States
(12) Patent Application Publication
(10) Pub. No.: US 2012/0323481 A1
(43) Pub. Date: Dec. 20, 2012

(54) NAVIGATING OUT OF A PARKING LOT

(75) Inventors: Sukadev Bhattiprolu, Beaverton, OR (US); Venkateswararao Jujjuri, Beaverton, OR (US); Haren Myneni, Tigard, OR (US); Malahal R. Naineni, Tigard, OR (US); Badari Pulavarty, Beaverton, OR (US); Chandra Seetharaman, Portland, OR (US); Narasimha N. Sharoff, Beaverton, OR (US)

(73) Assignee: INTERNATIONAL BUSINESS MACHINES CORPORATION, Armonk, NY (US)

(21) Appl. No.: 13/164,245

(22) Filed: Jun. 20, 2011

(51) Int. Cl. G01C 21/34

(52) U.S. Cl. 701/410; 701/445

(57) ABSTRACT

In a method for selecting a parking lot exit, a computer receives geographic coordinates of a first parking exit of a parking facility. The computer receives geographic coordinates of a second parking exit of the parking facility. The computer determines a first route from the first parking exit to a destination, using the geographic coordinates of the first parking exit. The computer determines a second route from the second parking exit to the destination, using the geographic coordinates of the second parking exit. The computer selects one of the first parking exit and the second parking exit based on the first route and the second route.

### TECHNICAL FIELD

The present invention relates generally to navigation systems and more specifically to navigating out of a parking lot.

### BACKGROUND

Global positioning systems (GPS) are commonly used for navigation. A user traveling with a GPS device provides the GPS device with a destination point. The GPS device then uses data obtained from GPS satellites to determine the current location of the user and the GPS device. The GPS device determines a route from the current location point to the destination point using electronic maps and assists the user in navigating to the destination point.

When a user and the GPS device are located in a parking lot or parking garage, however, the GPS device may not determine the most efficient route to a destination. Specifically, a parking garage often has more than one exit. A GPS device does not take into account the different exists in determining a route to the destination from the parking garage. Instead, the GPS device assumes that the user has equal access to all surrounding roads in determining a path to the destination. A parking garage may not have exits leading to all surrounding roads, however. Also, of the surrounding roads that do have parking garage exits leading to them, exiting to one road via a first exit may result in a more efficient route to the destination point as compared with exiting to a second road via a second exit, even though the user may be closer to the second exit.

FIG. 1 illustrates an example automobile 106 in a parking lot 102. Parking lot 102 has a first exit 108, leading to Front Street 114, and a second exit 110, leading to Back Road 116. Back Road 116 leads directly to Main Street 112 while Front Street 114 takes a detour 138 around obstacle 140 to reach Main Street 112. Automobile 106 is located in parking lot 102, in a region closest to Main Street 112. Automobile 106 has a GPS navigation device 120 for navigating to a destination. GPS navigation device 120 can be a known GPS navigation device, such as Nuvi® from Garmin. If, for example, a driver of automobile 106 desires to navigate to destination 104, GPS navigation device 120 in automobile 106 may select the shortest route and suggest to the driver to take Main Street 112 to Side Street 118, since Main Street 112 is the closest street to the current position of automobile 106. Main Street 112, however, is not directly accessible from parking lot 102. Front Street 114 and Back Road 116, in this example, are accessible from parking lot 102. GPS navigation device 120, however, does not have information about the different exits in parking lot 102, and therefore, would not take into account first exit 108 and second exit 110 when suggesting to the driver a route to destination 104.

Known GPS repeaters or re-transmitters enable a GPS device to retrieve position information from a GPS satellite, even while inside a parking garage. However, GPS repeaters and re-transmitters do not provide any information to the GPS device about the parking garage exits.

### SUMMARY

In a first embodiment of the present invention, a method is provided for selecting a parking lot exit. A computer receives geographic coordinates of a first parking exit of a parking facility. The computer receives geographic coordinates of a second parking exit of the parking facility. The computer determines a first route from the first parking exit to a destination, using the geographic coordinates of the first parking exit. The computer determines a second route from the second parking exit to the destination, using the geographic coordinates of the second parking exit. The computer selects one of the first parking exit and the second parking exit based on the first route and the second route.

In a second embodiment of the present invention, a system is provided for navigating out of a parking facility. A first transmitter is positioned at a first parking exit to transmit geographic coordinates of the first parking exit. A second transmitter is positioned at a second parking exit to transmit geographic coordinates of the second parking exit. A computer has a receiver to receive the geographic coordinates of the first parking exit and the geographic coordinates of the second parking exit. The computer determines a first route from the first parking exit to a destination, using the geographic coordinates of the first parking exit. The computer determines a second route from the second parking exit to the destination, using the geographic coordinates of the second parking exit. The computer selects one of the first parking exit and the second parking exit based on the first route and the second route.

In a third embodiment of the present invention, a system is provided for navigating out of a parking facility. A first computer, positioned in a parking facility, has a database for storing geographic coordinates of a plurality of parking exits of the parking facility. The computer has a transmitter for transmitting the geographic coordinates of the plurality of parking exits. A second computer has a receiver for receiving the geographic coordinates of the plurality of parking exits. The second computer determines a route from each of the plurality of parking exits to a destination, using the geographic coordinates of the plurality of parking exits. The second computer selects one of the plurality of parking exits based on the plurality of routes.

### BRIEF DESCRIPTION OF THE SEVERAL VIEWS OF THE DRAWINGS

FIG. 1 illustrates an example known parking lot.

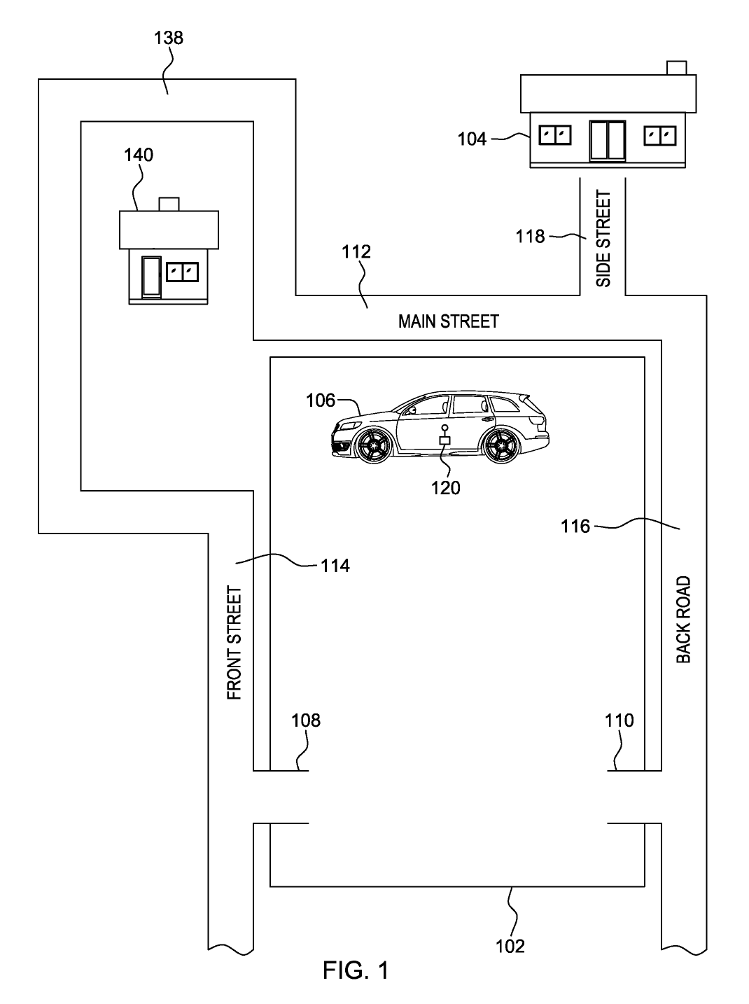

FIG. 2 illustrates an example system for navigating out of a parking facility, according to one embodiment of the present invention.

FIG. 3 illustrates a flow chart of the parking exit program of FIG. 2 for selecting a parking lot exit, according to one embodiment of the present invention.

FIG. 4 illustrates a flow chart of the parking exit program of FIG. 2 for selecting a parking lot exit, according to another embodiment of the present invention.

### DETAILED DESCRIPTION

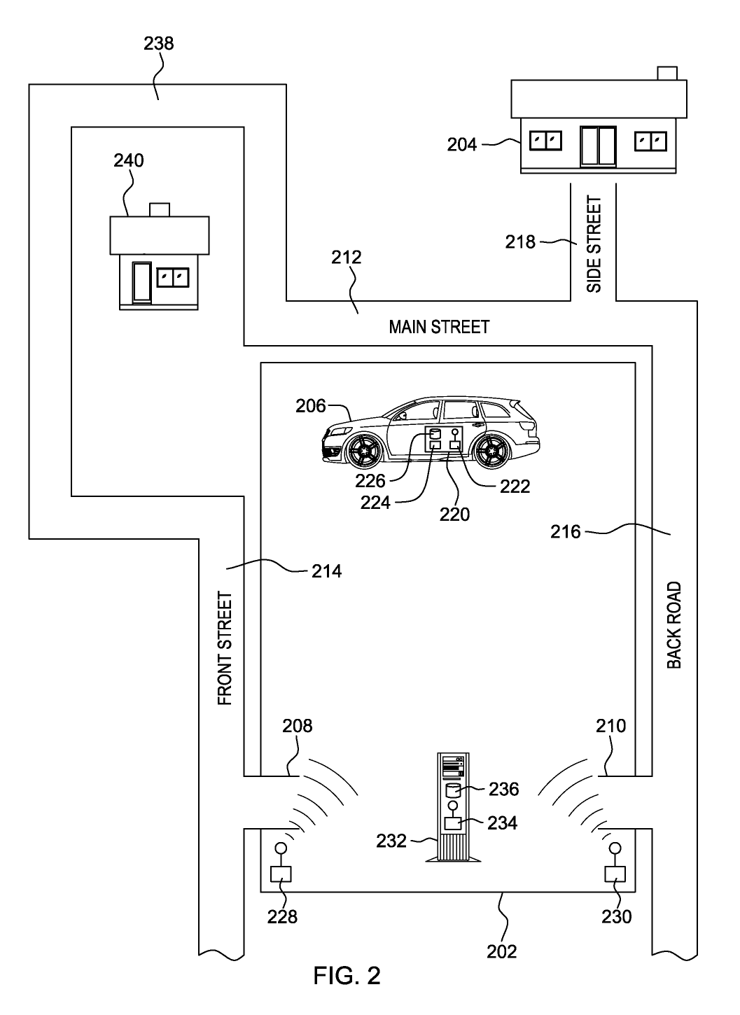

The present invention will now be described with reference to the figures. FIG. 2 illustrates an example system for navigating out of a parking facility, according to one embodiment of the present invention. Parking lot 202 has a first exit 208 and a second exit 210. First exit 208 leads out to Front Street 214. Second exit 210 leads out to Back Road 216. Back Road 216 leads directly to Main Street 212 while Front Street 214 takes a detour 238 around obstacle 240 to reach Main Street 212. Side Street 218 runs perpendicular to Main Street 212 and leads to destination 204.

It should be understood that, although the example system for navigating out of a parking facility will be described herein with regard to the example parking lot having two exits leading to two different example streets, the example system for navigating out of a parking facility can be used in a parking lot having any number of exits leading to any number of streets, of varying names. As will be discussed, the example system can be used in a parking garage with only one exit, for the purpose of determining a route to a destination while inside a closed parking garage where a GPS signal is not available. It should also be understood that, although the example system navigating out of a parking facility will be described herein with regard to a parking lot, a parking lot can include different types of parking facilities, such as parking garages and multi-level parking facilities, for example.

Parking lot 202 has a first exit location transmitter 228 located at first exit 208 and a second exit location transmitter 230 located at second exit 210. First and second exit location transmitters 228 and 230 transmit their location coordinates, respectively, via a wireless local area network protocol, such as 802.11 or via Bluetooth for example. In one example embodiment, first and second exit location transmitters 228 and 230 are pre-programmed with their respective location coordinates. In another example embodiment, first and second exit location transmitters 228 and 230 may obtain their location coordinates from a central server 232. Central server 232 may store location coordinates for a plurality of exit location transmitters in central database 236. Thus, if a systems administrator relocates an exit location transmitter, the systems administrator simply changes the stored location, for the exit location transmitter, in central database 236 of central server 232, rather than reprogramming the exit location transmitter. In yet another embodiment, first and second exit location transmitters 228 and 230 may retrieve their respective location coordinates via GPS.

It should be understood that, although the example system for navigating out of a parking facility is described having an exit location transmitter for transmitting location data for each exit respectively, the exit location transmitters may be substituted with a single exit location transmitter located in a single location. For example, central server 232 may include a central database 236 for storing location coordinates for first exit 208 and for second exit 210. Central server 232 may also include a transmitter 234 for transmitting the location coordinates of both first exit 208 and second exit 210. Alternatively, both first and second exit location transmitters 228 and 230 may store data for both first and second parking lot exits 208 and 210. For example, when automobile 206 enters parking lot 202 via parking exit 208, parking lot transmitter 228 may automatically transmit data about both first parking exit 208 and second parking exit 210 to automobile 206.

Automobile 206 in parking lot 202 has a navigation device 220 for navigating a driver of automobile 206 to a destination 204. Navigation device 220 can be a portable computer, mobile telephone, a GPS device, or other similar mobile computing device. Navigation device 220 includes an exit location receiver 222 for receiving exit location coordinates transmitted by first and second exit location transmitters 228 and 230.

Navigation device 220 has a parking exit program 224 for receiving parking exit data via parking exit transmitters 228 and 230, for calculating a route from first and second parking exits 228 and 230 to destination 204, and for selecting a parking exit, based on a destination 204 that will result in the fastest route to destination 204. In an example embodiment, parking exit program 224 accesses an internal map stored in map database 226 for calculating routes. In another example embodiment, parking exit program 224 accesses a map on the Internet such as Google Maps for calculating routes.

It should be understood that, although exit location receiver 222, parking exit program 224, and map database 226 are described as being integrated into navigation device 220, such as a mobile telephone or mobile computer, which may or may not have GPS capabilities for navigating a user to a final destination, exit location receiver 222, parking exit program 224, and map database 222 may also be integrated into a known GPS device. Such an integrated GPS device may assist a user in both selecting an appropriate exit of a parking lot as well as assist the user in navigating to a destination once the user exists the parking lot. In an example embodiment, such an integrated GPS device may also take into consideration traffic conditions when assisting a user in selecting a parking exit. For example, the GPS integrated device may select an alternate exit, even if the distance to a final destination is greater via the alternate exit, if the integrated GPS device determines that a first road at a first exit is under construction.

It should be understood that, although the example navigation device 220 is described in association with an automobile, navigation device 220 may also be used in association with a motorcycle, a bicycle, or with other forms of transportation, or by a pedestrian, where a user may benefit from such a device in order to navigate out of a parking lot.

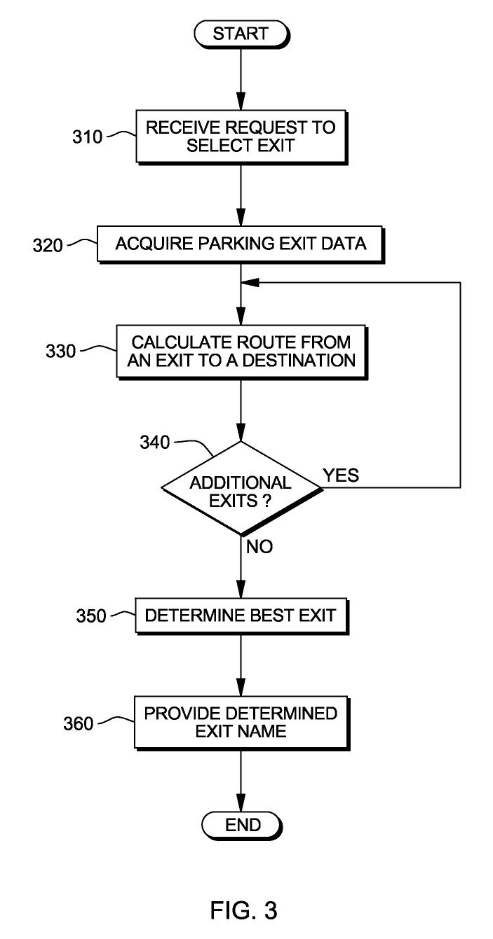

FIG. 3 illustrates in more detail the steps performed by the parking exit program 224 of navigation device 220 in FIG. 2 for selecting a parking exit, according to one embodiment of the present invention. At step 310, parking exit program 224 receives a request to select a parking exit for exiting a parking lot, to proceed to destination 204. In one example embodiment, the request is received via a user input device such as a touch screen for example. In another example embodiment, the request is received from a GPS device with which parking exit program 224 may be integrated. For example, a user may submit a request, via a GPS device, for a route to destination 204. A GPS device may then communicate with parking exit program 224 to first determine an appropriate parking exit before assisting the user in navigating to the destination.

At step 320, parking exit program 224 acquires parking exit data, including the name of the exit and location coordinates. For example, parking exit data may include “Front Street exit −37.7 N 122.2 W.” In an example embodiment, parking exit program 224 acquires parking exit data from first and second parking exit transmitters 228 and 230, via parking exit receiver 222.

In another example embodiment, parking exit program 224 acquires parking exit data from transmitter 234 of central server 232. Parking exit receiver 222 acquires parking exit data via 802.11, Bluetooth, or other similar wireless communication protocol.

At step 330, parking exit program 224 calculates a route from a parking exit to a destination. For example, parking exit program 224 calculates a route from parking exit 208 to destination 204. Parking exit program 224 calculates the route by identifying both the parking exit and the destination on a map and determining the route required to arrive at the destination from the parking lot. Based on the determined route, parking exit program 224 calculates the travel distance for the route. Alternatively, Parking exit program 224 may calculate the travel time for the route.

At step 340, parking exit program 224 determines whether there are additional parking exits for which to calculate routes. If parking exit program 224 determines that there are additional parking exits (decision 340, yes branch), then parking exit program 224 repeats step 330 and calculates a route for the next parking exit.

When parking exit program 224 has completed calculating routes for all parking exits (decision 340, no branch), then parking exit program 224 selects the parking exit resulting in the shortest travel distance to the destination, at step 350. Alternatively, parking exit program 224 may select the parking exit resulting in the shortest travel time to the destination. For example, parking exit program 224 may select exit 210 since parking exit 210 leads to Back Road which then leads directly to Main Street 212 whereas parking exit 208 leads to Front Street 214 which leads to Main Street 212 via detour 238.

At step 360, parking exit program 224 provides the selected parking exit to a user. For example, parking exit program 224 may suggest to the user to “use Front Street exit.” Parking exit program 224 may provide the suggestion via a visual interface such as a display screen, via an audible interface such as a speaker, via a combination of both an audible and a video interface, or via some other similar type of user interface.

In an example embodiment, parking exit program may provide the selected parking exit, including geographic coordinates, to a GPS navigation program, via a programming interface. A GPS navigation system may then use the selected exit to assist the user in navigating to the destination. For example, while inside a closed parking garage, a GPS navigation system may not be capable of receiving a GPS signal in order to determine a current position. Nevertheless, the GPS navigation system may utilize the geographic coordinates of the selected parking exit to determine a route to a destination, before exiting the closed parking garage and receiving a GPS signal.

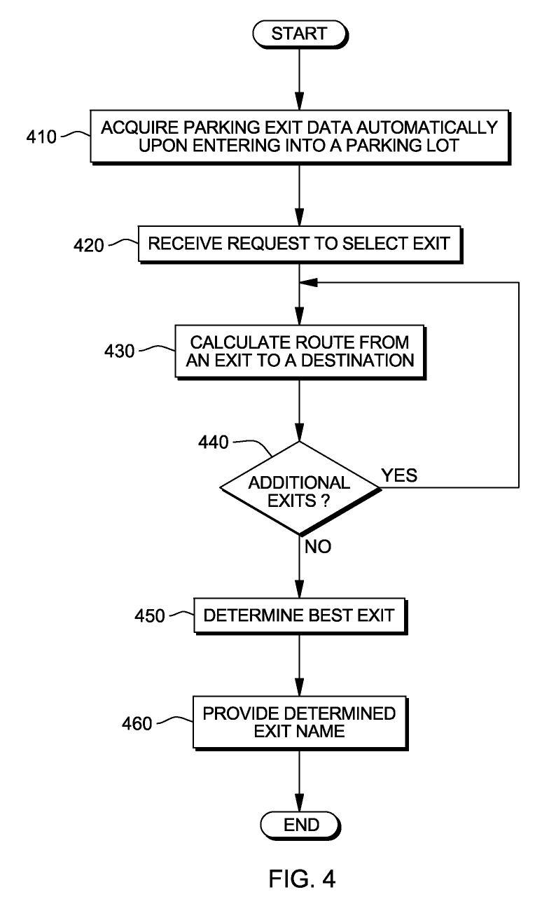

FIG. 4 illustrates in more detail the steps performed by the parking exit program 224 of navigation device 220 in FIG. 2 for selecting a parking exit, according to another embodiment of the present invention. At step 410, parking exit program acquires parking exit data automatically upon entry into a parking lot. At step 420, parking exit program 224 receives a request to select a parking exit for exiting a parking lot, to proceed to destination 204.

At step 430, parking exit program 224 calculates a route from a parking exit to a destination. At step 440, parking exit program 224 determines whether there are additional parking exits for which to calculate routes. If parking exit program 224 determines that there are additional parking exits (decision 440, yes branch), then parking exit program 224 repeats step 430 and calculates a route for the next parking exit.

When parking exit program 224 has completed calculating routes for all parking exits (decision 440, no branch), then parking exit program 224 selects the parking exit resulting in the shortest travel distance to the destination, at step 450. Alternatively, parking exit program 224 may select the parking exit resulting in the shortest travel time to the destination.

At step 460, parking exit program 224 provides the selected parking exit to a user. Alternatively, parking exit program may provide the selected parking exit directly to a GPS navigation program, via a programming interface, which may then use the selected exit to assist the user in navigating to the destination.

The description above has been presented for illustration purposes only. It is not intended to be an exhaustive description of the possible embodiments. One of ordinary skill in the art will understand that other combinations and embodiments are possible.

What is claimed is:

1. A method for selecting a parking lot exit, the method comprising the steps of:
a computer receiving geographic coordinates of a first parking exit of a parking facility;
the computer receiving geographic coordinates of a second parking exit of the parking facility;
the computer determining a first route from the first parking exit to a destination, using the geographic coordinates of the first parking exit;
the computer determining a second route from the second parking exit to the destination, using the geographic coordinates of the second parking exit; and
the computer selecting one of the first parking exit and the second parking exit based on the first route and the second route.

2. The method of claim 1, wherein the computer receives the geographic coordinates of the first parking exit and the geographic coordinates of the second parking exit automatically in response to entering the parking facility.

3. The method of claim 1, wherein the computer determines the first route and the second route by accessing an internal map.

4. The method of claim 1, wherein the computer determines the first route and the second route by using accessing a map wirelessly via the Internet.

5. The method of claim 1, wherein the computer selects one of the first parking exit and the second parking exit by:
comparing the travel distance for the first route and the second route; and
selecting a route having a shorter travel distance.

6. The method of claim 1, wherein the computer selects one of the first parking exit and the second parking exit by:
comparing the travel time for the first route and the second route; and
selecting a route having a shorter travel time.

7. The method of claim 1, further comprising the step of the computer presenting a name of the selected parking exit via a user interface.

8. A system for navigating out of a parking facility, the system comprising:
a first transmitter, positioned at a first parking exit, for transmitting geographic coordinates of the first parking exit;
a second transmitter, positioned at a second parking exit, for transmitting geographic coordinates of the second parking exit; and
a computer comprising:
a receiver for receiving the geographic coordinates of the first parking exit and the geographic coordinates of the second parking exit;
program instructions to determine a first route from the first parking exit to a destination, using the geographic coordinates of the first parking exit;
program instructions to determine a second route from the second parking exit to the destination, using the geographic coordinates of the second parking exit; and
program instructions to select one of the first parking exit and the second parking exit based on the first route and the second route.

9. The system of claim 8, wherein the first transmitter is pre-programmed with the geographic coordinates of the first exit and the wherein the second transmitter is pre-programmed with the geographic coordinates of the second exit.

10. The system of claim 8:
wherein the first transmitter is pre-programmed with the geographic coordinates of the first exit and with the geographic coordinates of the second exit;
wherein the second transmitter is pre-programmed with the geographic coordinates of the first exit and with the geographic coordinates of the second exit;
wherein the first transmitter transmits the geographic coordinates of the first exit and the geographic coordinates of the second exit; and
wherein the second transmitter transmits the geographic coordinates of the first exit and the geographic coordinates of the second exit.

11. The system of claim 8, wherein the first transmitter obtains geographic coordinates of the first exit from a Global Positioning System and wherein the second transmitter obtains geographic coordinates of the second exit from a Global Positioning System.

12. The system of claim 8, wherein the first transmitter and the second transmitter transmit via a wireless local area network protocol.

13. The system of claim 8, wherein the receiver of the computer receives the geographic coordinates of the first parking exit and the geographic coordinates of the second parking exit automatically in response to entering the parking facility.

14. The system of claim 8, wherein the computer further comprises program instructions to present a name of the selected parking exit via a user interface.

15. A system for navigating out of a parking facility, the system comprising:
a first computer, positioned in a parking facility, comprising:
a database for storing geographic coordinates of a plurality of parking exits of the parking facility; and
a transmitter for transmitting the geographic coordinates of the plurality of parking exits; and
a second computer comprising:
a receiver for receiving the geographic coordinates of the plurality of parking exits;
program instructions to determine a route from each of the plurality of parking exits to a destination, using the geographic coordinates of the plurality of parking exits; and
program instructions to select one of the plurality of parking exits based on the plurality of routes.

16. The system of claim 15, wherein the transmitter transmits via a wireless local area network protocol.

17. The system of claim 15, wherein the receiver receives the geographic coordinates automatically in response to entering the parking facility.

18. The system of claim 15, wherein the second computer further comprises program instructions to present a name of the selected parking exit via a user interface.
